(19) United States
(12) Patent Application Publication
(10) Pub. No.: US 2009/0089069 A1
(43) Pub. Date: Apr. 2, 2009

(54) METHOD FOR DEREGISTRATION OF REMOVED TELECOMMUNICATION MODULE

(75) Inventors: Douglas J. McKibbon, Farmington, MI (US); Robert J. Casper, Canton, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: General Motors Corporation, Detroit, MI (US)

(21) Appl. No.: 11/865,058

(22) Filed: Sep. 30, 2007

(51) Int. Cl. G06Q 99/00

(52) U.S. Cl. 705/1

(57) ABSTRACT

A method for deregistering a module removed from a telematics unit associated with a vehicle employs a network-based deregistration interface for module data uniquely identifying the removed module as well as optionally for uniquely identifying the vehicle owner or subscriber and the vehicle, e.g., a subscriber ID and VIN. The interface may also comprise one or more authentication fields for receiving and transmitting authentication data.

### BACKGROUND OF THE INVENTION

As wireless communications become more commonplace, the need and desire to have wireless access has now extended into almost every environment of human activity, so that personal wireless communication devices are close at hand at all times for many people. When driving, a user may not have ready access to their handheld wireless device, but many automobiles are now equipped with built in telematics capabilities. Such devices not only allow communications for purposes of convenience, but also often serve an emergency notification function when users are in need of assistance, so that these devices are very popular.

As with any wireless device, however, it is still generally necessary to register such devices with a service provider so that they may provide service and receive compensation in an agreed manner. Moreover, as with any system, it also sometimes becomes necessary to remove an existing telematics module and deregister it to allow registration of a replacement module. For example, a hardware upgrade may be required that can only be accomplished via replacement of a portion of the existing telematics unit. Alternatively, an existing module may be, or become, faulty beyond reasonable repair, requiring replacement of the module with a similar module. For modules that are registered specifically with the service provider, it is important to deregister the removed module and register, in its place, the new module.

Traditionally, the deregistration of a module has been accomplished by requiring the servicing facility that is replacing the module to send the removed module to the service provider for processing. Although this widely used practice is known to be time-consuming, error-prone, and costly, the industry has been unable to devise a more efficient and accurate manner in which to complete the deregistration of modules.

A system is needed whereby replacement telematics modules may be deregistered with the appropriate service provider without the delay, inaccuracy, and cost inherent in prior systems.

### BRIEF SUMMARY OF THE INVENTION

In an aspect of the disclosed principles, if a telecommunication module is removed from a vehicle, the service provider needs to be able to receive information regarding the module, so that one or more active components can be turned off. In a disclosed example, the required information is sent to the service provider, but the device itself is not. The information transmission is facilitated in one example by a web interface exposed to the authorized replacement personnel, along the replacement personnel to quickly and efficiently identify the module for deregistration while also providing the necessary information to allow such deregistration to be executed.

From the service provider's perspective, the disclosed examples of the invention allow the service provider to understand which telecommunications modules have been removed from vehicles, without having to physically receive the relevant modules in the mail. Not only does this save the costs associated with shipping, but it also avoids costs at the recipient for processing and storing the deregistered module. In particular, by providing an effective interface to allow a dealer to enter and transmit the removed telecommunication module identification information, the need to mail the module back to service provider is eliminated.

### BRIEF DESCRIPTION OF THE SEVERAL VIEWS OF THE DRAWING(S)

FIG. 1 is a schematic view of an example communication system within which examples of the present invention may be implemented;

FIG. 2 is a general overview of system architecture in keeping with the disclosed principles;

FIG. 3 is a further architectural overview in keeping with the disclosed principles;

FIG. 4 is an interface diagram and computing environment schematic illustrating an interface according to the described principles; and

FIG. 5 is a flow diagram that illustrates an exemplary method of deregistering a module of a telematics unit.

### DETAILED DESCRIPTION OF THE INVENTION

Before describing the invention in detail, an exemplary environment in which the invention may operate will be described. It will be appreciated that the described environment is for purposes of illustration only, and does not imply any limitation regarding the use of other environments to practice the invention.

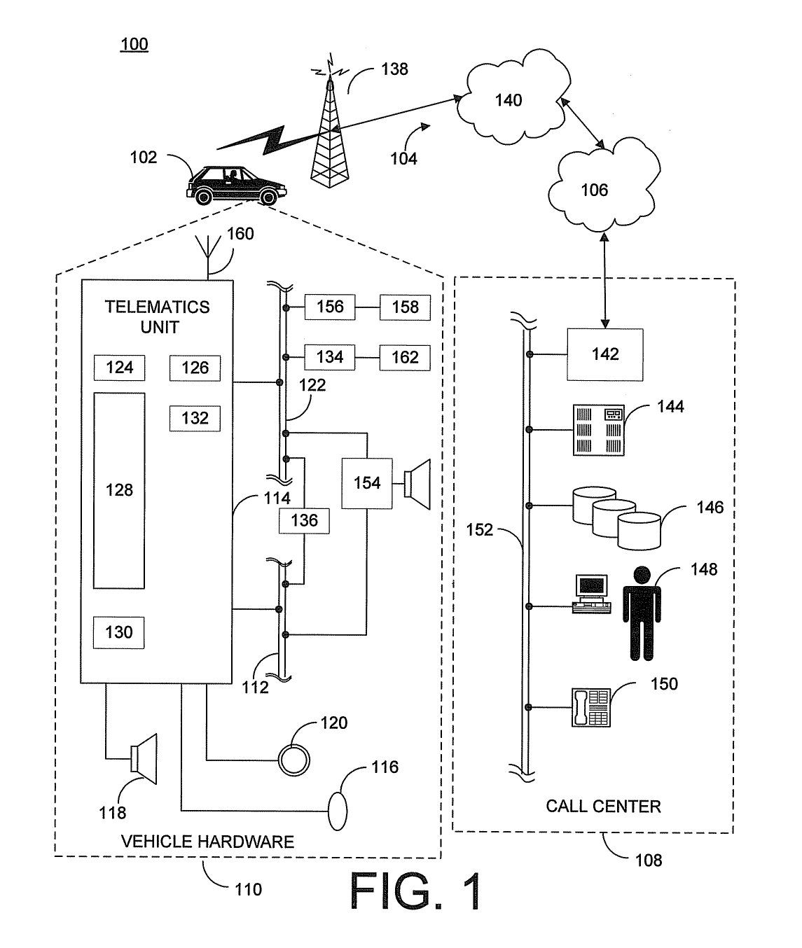

With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128. The cellular chipset/component 124 and the wireless modem 126 may be called the network access device (NAD) 180 of the telematics unit.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 180. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing.

The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

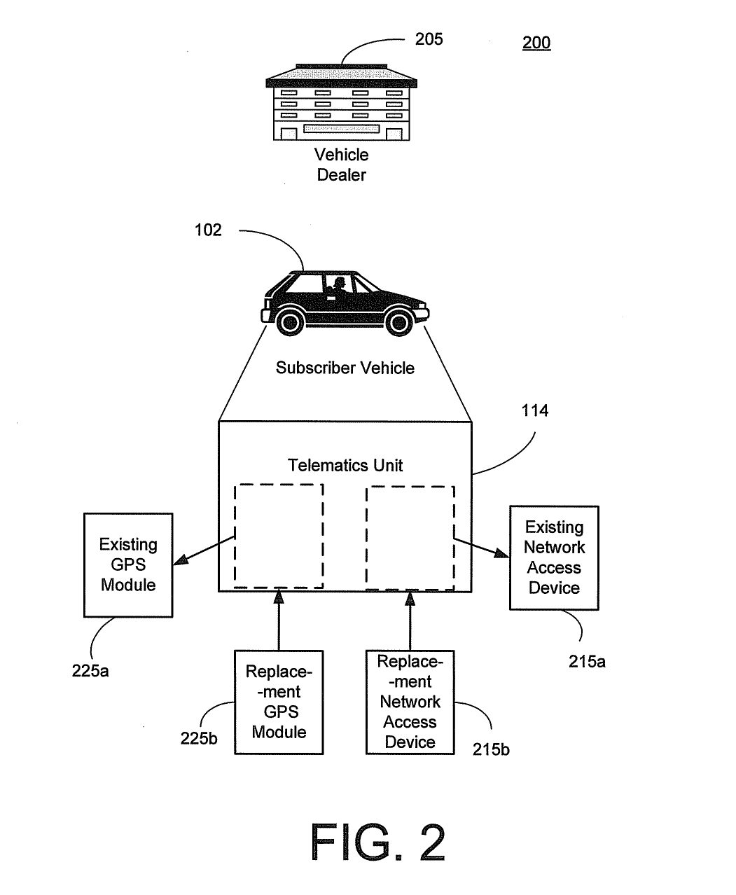

As noted above, certain aspects of the invention allow vehicle service personnel to transfer deregistration information regarding removed modules automatically through a provider network interface without physically transferring a removed module. Given the received data regarding the removed module, the service provider may then automatically or manually deregister the module of interest. FIG. 2 is a schematic overview 200 of an exemplary architecture usable in implementing the disclosed principles. The illustrated architecture shows an authorized repair facility or vehicle dealer 205 and a subscriber vehicle 102. The subscriber vehicle 102 comprises existing GPS unit 225a and existing network access device (NAD) 215a. For repair or upgrade, either or both of existing GPS unit 225a and existing NAD 215a are to be replaced by respective ones of replacement GPS unit 225b and replacement NAD 215b.

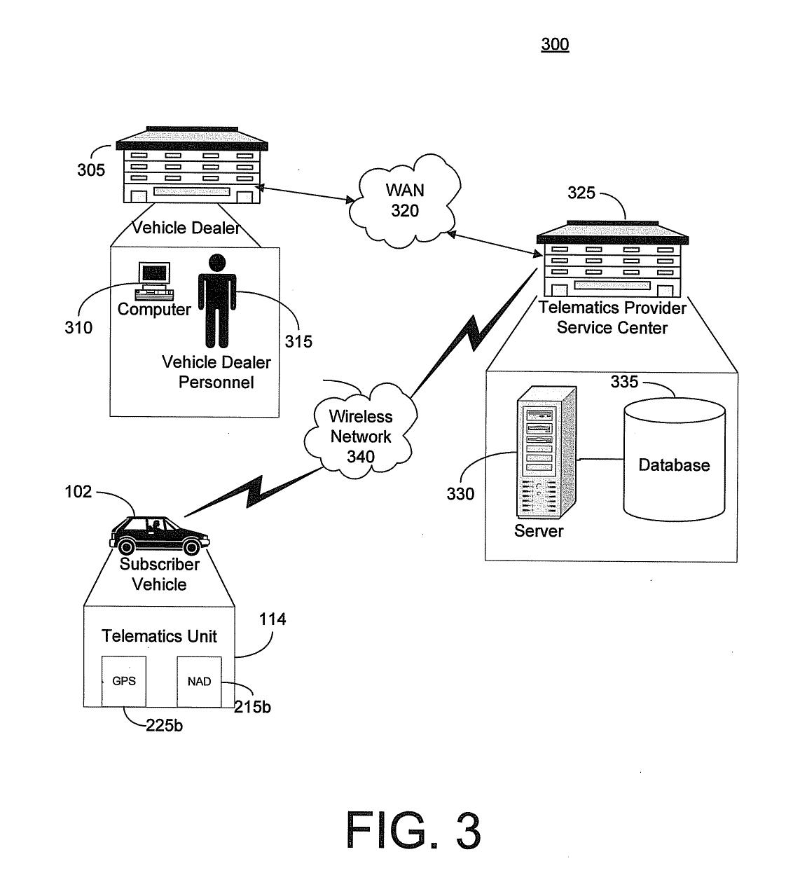

FIG. 3 is a schematic overview 300 showing additional and alternative aspects of an implementation of the invention. The vehicle dealer 305 accesses a telematics service provider web or network interface 309 from a computer 310 such as a PC, handheld, laptop, or other computing device, over the Internet 320 (or other wide area network). Vehicle dealer personnel 315 then enter pertinent telematics unit and module information regarding an existing module into the provider network interface during replacement of the module. A server 330 at a telematics service provider center receives this information and stores it in one or more databases 335 to execute deregistration of the module being replaced. Once the replacement module(s) 215b, 225b is (are) installed and the telematics unit in the subscriber's vehicle 102, they may be registered in lieu of the removed module(s).

It will be appreciated that the network interface, e.g., web site, exposed to dealer personnel 315 may be for example an interactive HTML document exposed by server 30 or the network 320. The server 30 preferably implements verification or other security processes to authenticate the dealer personnel 315. For example, exchanged data may be encrypted by key-based or other cryptography and the server 30 may require a password or other authorization for access to the interface.

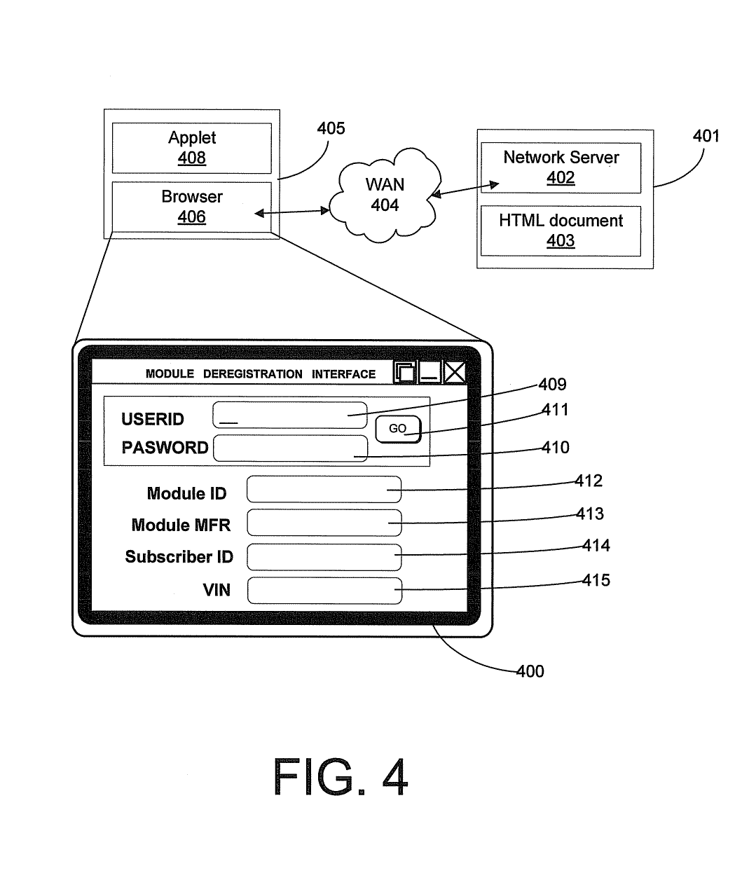

FIG. 4 is a schematic view of the interface 400 and associated system components. The server 401, corresponding to server 30, comprises a network server 402 as well as a memory module containing an HTML document 403 or other representation of the interface 400. The server 401 is linked via the WAN 404 (320) to a dealer computing device 405 (310) having thereon a browser 406 or other module for interfacing with a network and processing and displaying received data. The server may also comprise within active memory an applet 408 or other element usable to allow interactivity within interface 400.

Referring to the interface 400 in greater detail, in the illustrated example, the interface 400 includes a number of active and fillable fields including a USERID field 409 and a PASSWORD field 410. Once the involved dealer personnel have entered the appropriate USERID and PASSWORD into fields 409 and 410, the personnel activate the “GO” button by selecting it and the entered ID and password are transmitted over network 404 to the server 401 for authentication. The server 401 may but need not return an indication that access has been granted if the entered ID and password are correct.

Next the personnel enter the information needed to specifically identify the module to be deregistered. In the illustrated example, the information includes a module ID (field 412), a module manufacturer (field 413), a subscriber ID (field 414), and a vehicle identification number VIN (field 415) for the vehicle hosting the telematics unit from which the module to be deregistered is being removed. The entered information in fields 412-414 may be sent as it is entered or may sent to the server 402 as a batch after the user indicates that entry is complete. The Server 402 then uses the entered information to deregister the removed module.

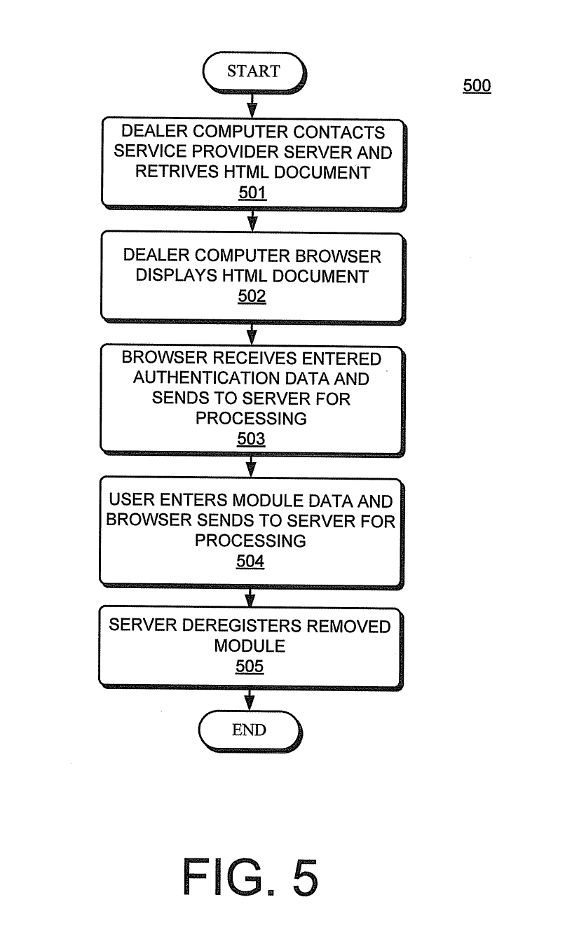

FIG. 5 is a flow diagram that illustrates an exemplary method of deregistering a removed telematics unit module in keeping with the disclosed principles. At stage 501, the dealer computer 405 contacts the service provider server 401 and retrieves the html document 403, which the dealer computer browser 406 displays as interface 400 at stage 502. The browser 406 then receives authentication data entered by the user and sends the received authentication data to the server 401 for processing at stage 503. At stage 504, the authenticated user enters the required module data to uniquely identify the removed module, which the browser 406 sends to the server 401 for processing at stage 504. Having identified the removed module, the server 401 deregisters the removed module at stage 505. Given the teachings herein, those of skill in the art will be familiar with the steps needed to complete the deregistration once the module is identified.

It will be appreciated that an improved system of telematics module deregistration has been disclosed herein. All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for deregistering a module removed from a telematics unit associated with a vehicle, the method comprising:
receiving a request from a source computing device over a network for a deregistration interface;
transmitting data corresponding to the deregistration interface over the network to the source computing device, whereupon the deregistration interface is displayed on a screen of the source computing device;
receiving over the network, from the source computing device, module data entered by a user of the source computing device, wherein the module data uniquely identifies the module removed from the telematics unit; and
deregistering the module in response to receipt of the module data uniquely identifying the module.

2. The method according to claim 1, further comprising receiving authentication data from the user of the source computing device and verifying that the user is authorized to deregister the module.

3. The method according to claim 1, wherein receiving module data entered by a user of the source computing device comprises receiving the module data from a browser on the source computing device, wherein the browser is hosting the deregistration interface.

4. The method according to claim 1, wherein the network comprises a wide area network.

5. The method according to claim 1, wherein the module removed from the telematics unit comprises a GPS module.

6. The method according to claim 1, wherein the module removed from the telematics unit comprises a NAD module.

7. The method according to claim 1, wherein the module data comprises a module identification unique to the module removed from the telematics unit.

8. The method according to claim 1, wherein the module data further comprises a subscriber identification and a vehicle identification unique to the vehicle hosting the telematics unit.

9. A method for deregistering a module removed from a telematics unit associated with a vehicle, the method comprising:
sending a request from a dealer computer to a provider server over a network for a deregistration interface;
receiving data corresponding to the deregistration interface over the network, and displaying the deregistration interface on a screen of the dealer computer; and
sending over the network, from the dealer computer to the provider server, module data entered by a user of the dealer computer, wherein the module data uniquely identifies the module removed from the telematics unit, whereupon the provider server deregisters the module in response to receipt of the module data uniquely identifying the module.

10. The method according to claim 9, further comprising sending authentication data from the user of the dealer computer to the provider server to verify that the user is authorized to deregister the module.

11. The method according to claim 9, wherein sending module data entered by a user of the dealer computer comprises sending the module data from a browser on the dealer computer, wherein the browser hosts the deregistration interface.

12. The method according to claim 9, wherein the network comprises a wide area network.

13. The method according to claim 9, wherein the module removed from the telematics unit comprises a GPS module.

14. The method according to claim 9, wherein the module removed from the telematics unit comprises a NAD module.

15. The method according to claim 9, wherein the module data comprises a module identification unique to the module removed from the telematics unit.

16. The method according to claim 9, wherein the module data further comprises a subscriber identification and a vehicle identification unique to the vehicle hosting the telematics unit.

17. An interface for display on a computer for deregistering a module removed from a telematics unit of a vehicle owned by an owner, the interface comprising:
an authentication field for entry of authentication data associated with a used of the computer; and
a plurality of identification fields for receiving information uniquely identifying the module removed from the telematics unit.

18. The interface of claim 17, wherein the authentication field further comprises a password field and a user identification field.

19. The interface of claim 17, wherein the plurality of identification fields comprise a one or more fields that uniquely identify the module.

20. The interface of claim 17, wherein the plurality of identification fields further comprise one of a subscriber identification field for identifying the vehicle owner and a vehicle identification field for uniquely identifying the vehicle.
